(19) United States
(12) Patent Application Publication
(10) Pub. No.: US 2014/0103853 A1
(43) Pub. Date: Apr. 17, 2014

(54) MOTOR CONTROL DEVICE

(71) Applicants: Jun Yoshida, Tokyo (JP); Akira Tanabe, Tokyo (JP); Kazuaki Ando, Tokyo (JP)

(72) Inventors: Jun Yoshida, Tokyo (JP); Akira Tanabe, Tokyo (JP); Kazuaki Ando, Tokyo (JP)

(73) Assignee: Mitsubishi Electric Corporation, Chiyoda-ku, Tokyo (JP)

(21) Appl. No.: 14/122,968

(22) PCT Filed: Jun. 20, 2011
(86) PCT No.: PCT/JP2011/064070

§ 371 Date: Nov. 27, 2013

(51) Int. Cl. B23Q 5/58

(52) U.S. Cl. CPC B23Q 5/58
USPC 318/563

(57) ABSTRACT

Motor drive information is sampled at a regular interval and stored in a storage unit, during a period when a normal operation is performed in accordance with a first command signal received from a controller. When an abnormality occurs, a second command signal with which a motor can be driven is internally generated from the motor drive information stored in the storage unit. When the abnormality occurs, the internally-generated second command signal is input as a command signal to a motor drive unit, and thereby it is possible to achieve a necessary retracting operation without any problem even if the first command signal cannot be obtained from the controller.

### FIELD

The present invention relates to a motor control device that performs a drive control of a motor based on a command signal received from a controller.

### BACKGROUND

For example, a motor control device used in a machining tool that performs machining, molding, and the like of a workpiece is configured to perform a drive control of a motor in the machining tool based on a command signal received from a controller.

Such the motor control device used in the machining tool requires a function that forcibly terminates the machining, if an abnormality such as an electric power failure that disables normal driving of the motor is caused during an operation of the machining tool, to enable retraction of a tool and the workpiece to respective positions where no interference occurs between them. It should be noted that such the abnormality that disables normal driving of the motor includes, for example, a case where the motor cannot be driven to properly follow the command signal received from the controller.

For example, Patent Literature 1 discloses a technique of retracting a tool and a workpiece to respective positions where no interference occurs between them, in a case of emergency stop of a motor control device due to occurrence of a machining stop reason such as a damage of the tool. Specifically, a controller constantly calculates and stores a tool retraction program that traces back a program executed by a numerical control device or the like used in a machining tool. The controller causes a motor to perform a retracting operation in accordance with the tool retraction program.

### CITATION LIST

### Patent Literature

Patent Literature 1: Japanese Patent Application Laid-open No. 2007-188170

### SUMMARY

### Technical Problem

However, there may be cases where the command signal cannot be obtained from the controller, such as a case where electric power for the controller is shutdown due to an electric power failure or the like and a case where an abnormality occurs in a communication line for transmitting the command signal from the controller. In such the cases, according to the technique described in Patent Literature 1, the command signal indicating the retracting operation is not supplied from the controller and thus the retracting operation for the tool and the workpiece cannot be executed, which is a problem.

Moreover, according to the technique described in Patent Literature 1, it is required to constantly calculate the tool retraction program by using a tool retraction formula and store the tool retraction program. Therefore, large-scale storage unit and calculation unit are required, which also is a problem.

The present invention has been achieved in view of the above problems, and an object of the present invention is to provide a motor control device that can cause a motor to perform a retracting operation without fail even when a command signal cannot be obtained from a controller in a case where an abnormality occurs.

### Solution to Problem

In order to solve the above-mentioned problems and achieve the above-mentioned object, a motor control device according to the present invention has: a motor drive unit configured to drive a motor to follow a command signal to be input; an abnormality detection unit configured to monitor whether or not an abnormality such as an electric power failure that disables normal driving of the motor occurs; a command switching unit configured to input, when the abnormality detection unit does not detect the abnormality, a first command signal received from a controller as the command signal to the motor drive unit, and to input, when the abnormality detection unit detects the abnormality, a second command signal generated within the motor control device as the command signal to the motor drive unit; a storage unit configured to sample, when the abnormality detection unit does not detect the abnormality, motor drive information in the motor drive unit at a regular interval and stores therein the sampled motor drive information; and a command generation unit configured to read, when the abnormality detection unit detects the abnormality, a predetermined number of pieces of the motor drive information in order of time from occurrence of the abnormality to past from the storage unit to generate the second command signal that causes a retraction path tracing back a trajectory of the motor from a time of the occurrence of the abnormality.

### Advantageous Effects of Invention

According to the present invention, the motor drive information is stored in the storage unit during a period when a normal operation is performed in accordance with the first command signal received from the controller. When an abnormality occurs, the second command signal with which the motor can be driven is internally generated from the motor drive information stored in the storage unit. It is therefore possible to achieve a necessary retracting operation without any problem even if the first command signal cannot be obtained from the controller.

### BRIEF DESCRIPTION OF DRAWINGS

FIG. 1 is a block diagram showing a configuration of a motor control device according to a first embodiment of the present invention.

FIG. 2 is a flowchart for explaining a procedure of a retracting operation performed by the motor control device shown in FIG. 1 when the motor control device detects an abnormality such as an electric power failure that disables normal driving of a motor.

FIG. 3 is an explanatory diagram of an operation (part 1) of generating an internal command signal by a command generation unit shown in FIG. 1.

FIG. 4 is an explanatory diagram of an operation (part 2) of generating an internal command signal by a command generation unit shown in FIG. 1.

FIG. 5 is a block diagram showing a configuration of a motor control device according to a second embodiment of the present invention.

FIG. 6 is a flowchart for explaining a procedure of a retracting operation performed by the motor control device shown in FIG. 5 when the motor control device detects an abnormality such as an electric power failure that disables normal driving of a motor.

FIG. 7 is an explanatory diagram of an operation of generating an internal command signal by a command generation unit shown in FIG. 5.

### DESCRIPTION OF EMBODIMENTS

Exemplary embodiments of a motor control device according to the present invention will be described below in detail with reference to the accompanying drawings. It should be noted that the present invention is not limited to the embodiments.

### First Embodiment

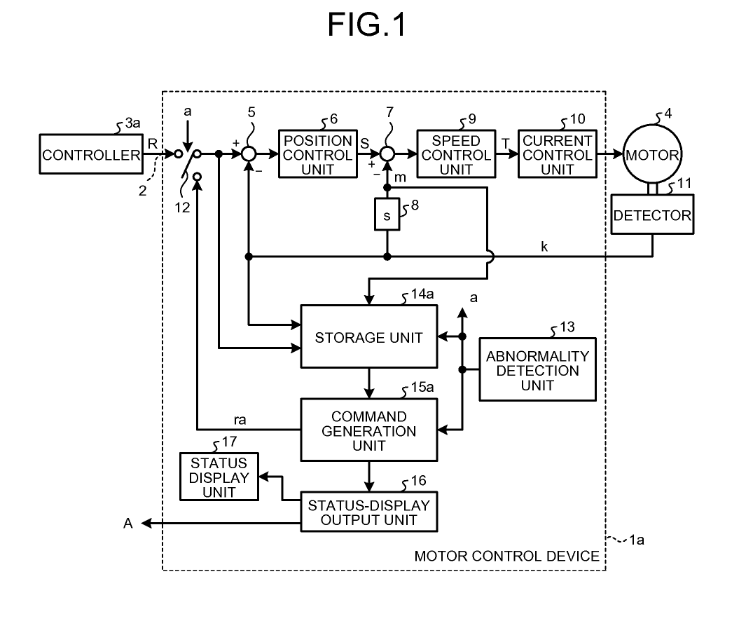

FIG. 1 is a block diagram showing a configuration of a motor control device according to a first embodiment of the present invention. In FIG. 1, a motor control device la according to the first embodiment includes error-component extraction units 5 and 7, a position control unit 6, a differentiating unit 8, a speed control unit 9, and a current control unit 10, as a basic configuration (corresponding to a “motor drive unit”) for performing a drive control of a motor 4 based on a command signal R (corresponding to a “first command signal”) input from a controller 3a to a communication port 2.

Here, the command signal R input from the controller 3a is a position command signal or a speed command signal. In FIG. 1, for the sake of explanations, the command signal R is assumed to be a position command signal. A detector 11 attached to the motor 4 detects a motor position k. The detected motor position k is input as a feedback signal to the error-component extraction unit 5 and the differentiating unit 8.

In addition to the basic configuration, the motor control device la according to the first embodiment further includes a switch 12 being a command switching unit, an abnormality detection unit 13, a storage unit 14a, a command generation unit 15a, a status-display output unit 16, and a status display unit 17, as a configuration for causing the motor 4 to perform a retracting operation at a time when an abnormality occurs.

First, the basic configuration for performing the drive control of the motor 4 based on the command signal R received from the controller 3a will be briefly described.

In the basic configuration for performing the drive control of the motor 4, the command signal R from the controller 3a is directly input to an addition input terminal (+) of the error-component extraction unit 5 through the communication port 2. The motor position k detected by the detector 11 attached to the motor 4 is input to a subtraction input terminal (−) of the error-component extraction unit 5 and the differentiating unit 8.

The error-component extraction unit 5 calculates a difference between the command signal R received from the controller 3a and the motor position k detected by the detector 11. The position control unit 6 performs processing including a proportional operation with respect to the position difference calculated by the error-component extraction unit 5 and outputs a speed command S for decreasing the position difference to an addition input terminal (+) of the error-component extraction unit 7. The differentiating unit 8 calculates a motor speed m by differentiating the motor position k, and the calculated motor speed m is input to a subtraction input terminal (−) of the error-component extraction unit 7.

The error-component extraction unit 7 calculates a speed difference of the speed command S output from the position control unit 6 and the motor speed m output from the differentiating unit 8. The speed control unit 9 performs processing including a proportional operation and an integration operation with respect to the speed difference calculated by the error-component extraction unit 7 and outputs a current command T for decreasing the speed difference to the current control unit 10. The current control unit 10 outputs a drive current for driving the motor 4, based on the current command T calculated by the speed control unit 9.

In this manner, the basic configuration for performing the drive control of the motor 4, including “the error-component extraction units 5 and 7, the position control unit 6, the differentiating unit 8, the speed control unit 9, and the current control unit 10”, performs an operation that drives the motor 4 to follow the command signal R input from the controller 3a.

Next, a configuration for causing the motor 4 to perform a retracting operation when an abnormality occurs will be described below with taking a machining tool for instance.

The abnormality detection unit 13 monitors occurrence of an electric power failure and a drive status of the motor 4 (such as whether or not the motor 4 is driven to follow the command signal R input from the controller 3a) during an operation of the machining tool, and notifies the switch 12, the storage unit 14a, and the command generation unit 15a of a monitor result indicating whether or not an abnormality occurs. The reason why the abnormality detection unit 13 notifies the occurrence of the electric power failure is to perform, when the electric power failure occurs, a retracting operation by using electric power remaining in capacitive components. The amount of electric power remaining at the time of the electric power failure is known in advance.

The switch 12 is provided between the communication port 2 for communicating with the controller 3a, the addition input terminal (+) of the error-component extraction unit 5, and an output terminal of the command generation unit 15a. In a case where the abnormality detection unit 13 detects no abnormality, the switch 12 inputs the command signal R input to the communication port 2 from the controller 3a to the addition input terminal (+) of the error-component extraction unit 5. Meanwhile, in a case where the abnormality detection unit 13 detects an abnormality, the switch 12 inputs an internal command signal ra (corresponding to a “second command signal”) output from the command generation unit 15a to the addition input terminal (+) of the error-component extraction unit 5.

The storage unit 14a includes a RAM and a control circuit. When the abnormality detection unit 13 detects no abnormality, the control circuit samples motor drive information at an arbitrarily-set regular interval and stores the sampled motor drive information in the RAM. Here, the motor drive information includes any one of or a combination of the position command or the speed command indicated by the command signal R input to the addition input terminal (+) of the error-component extraction unit 5, the motor position k detected by the detector 11, and the motor speed m calculated by the differentiating unit 8 from the motor position k. The storing of the motor drive information in the RAM is repeated in a manner that a predetermined number of pieces of the information are overwritten.

In the case where the abnormality detection unit 13 detects the abnormality, the command generation unit 15a reads the motor drive information that has been stored in the storage unit 14 at the regular interval, specifically reads a predetermined number of pieces of the motor drive information in order of time from the detection of the abnormality to the past. Then, the command generation unit 15a generates the internal command signal ra that causes a retraction path tracking back a pre-abnormality-occurrence motor drive trajectory from the time of the detection of the abnormality to the past, and outputs the generated internal command signal ra to the addition input terminal (+) of the error-component extraction unit 5 through the switch 12. As a result, the motor 4 is driven to perform the retracting operation based on the internal command signal ra instead of the command signal R. Therefore, when the abnormality occurs, the retracting operation can be achieved regardless of whether or not the command signal R can be obtained from the controller 3a.

Here, in a case where the abnormality detected by the abnormality detection unit 13 is an electric power failure, the command generation unit 15a generates a required number of internal command signals ra for causing the motor 4 to achieve the retracting operation within a range of the remaining amount of electric power. Meanwhile, in a case where the abnormality detected by the abnormality detection unit 13 is other than an electric power failure, the command generation unit 15a generates a required number of internal command signals ra for causing the motor 4 to achieve the retracting operation within a range of any one of a preset operation time and a preset operation distance.

The status-display output unit 16 displays, on the status display unit 17, a fact that the motor 4 is being driven in accordance with the internal command signal ra generated by the command generation unit 15a or the driving of the motor 4 is completed, and outputs the fact as a status signal A to the controller 3a. As a result, a user can recognize that the motor 4 has been driven by the internal command signal ra, that is, the motor 4 has performed the retracting operation.

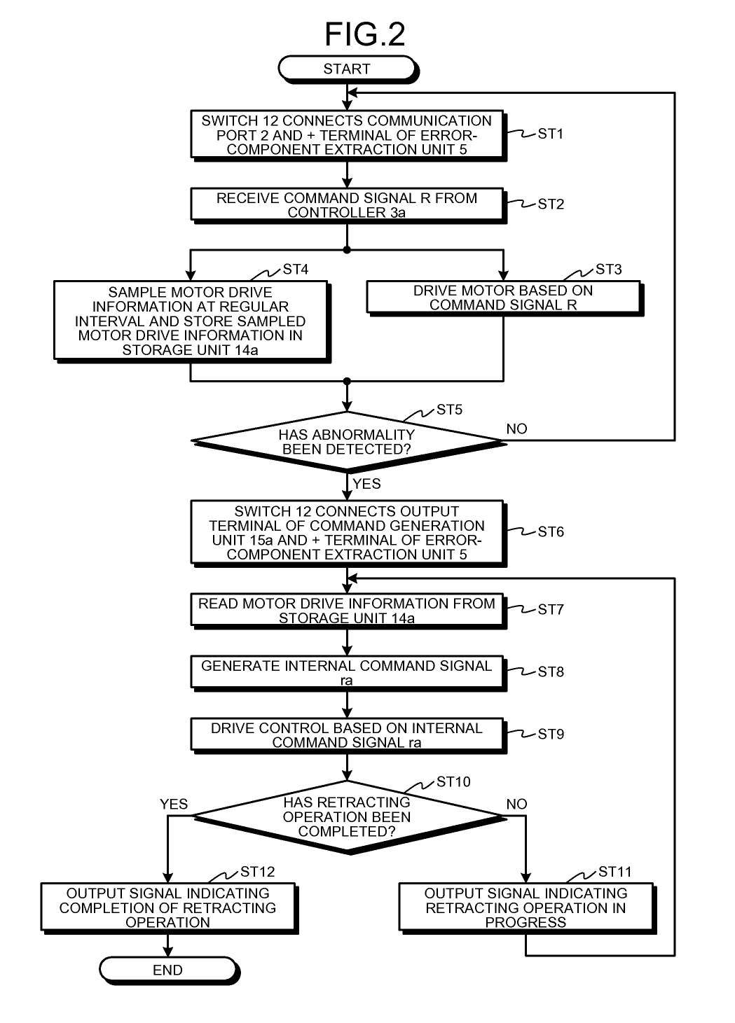

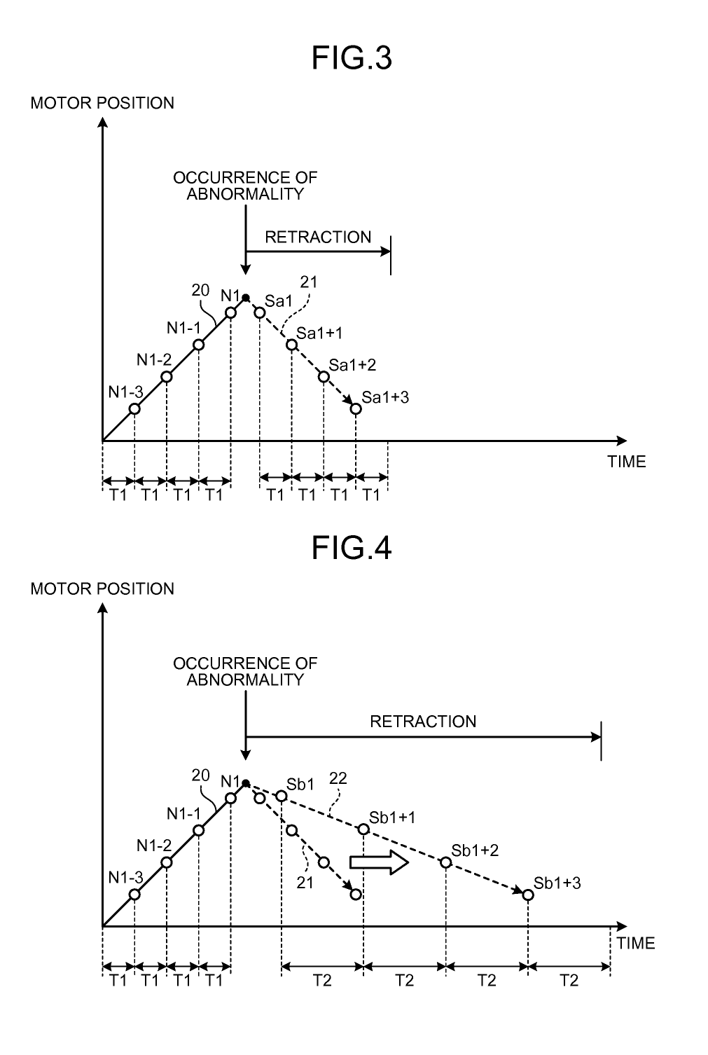

Next, the retracting operation according to the first embodiment will be described with reference to FIGS. 2 to 4. FIG. 2 is a flowchart for explaining a procedure of the retracting operation performed by the motor control device shown in FIG. 1 when the motor control device detects an abnormality such as an electric power failure that disables normal driving of the motor. In FIG. 2, a step indicating a process procedure is denoted by “ST”. FIGS. 3 and 4 are explanatory diagrams of an operation of generating the internal command signal by the command generation unit shown in FIG. 1.

In FIG. 2, at ST1, the switch 12 connects the communication port 2 and the addition input terminal (+) of the error-component extraction unit 5. As a result, the command signal R input from the controller 3a to the communication port 2 is input to the addition input terminal (+) of the error-component extraction unit 5 (ST2), and motor driving is performed based on the command signal R (ST3). Concurrently, the motor drive information is sampled at a regular interval and stored in the storage unit 14a (ST4). The processing of ST1 to ST4 is repeated (ST5: No), until the abnormality detection unit 13 detects occurrence of an abnormality.

If the abnormality detection unit 13 detects occurrence of an abnormality (ST5: Yes), the switch 12 switches the command signal to be input to the addition input terminal (+) of the error-component extraction unit 5 from the command signal R output from the controller 3a to the internal command signal ra generated and output by the command generation unit 15a (ST6).

When the abnormality detection unit 13 detects the occurrence of the abnormality (ST5: Yes), the command generation unit 15a reads a piece of the motor drive information from the storage unit 14a (ST7) and generates a single internal command signal ra (ST8). As a result, the single internal command signal ra is input to the addition input terminal (+) of the error-component extraction unit 5, and thus motor driving is performed based on the internal command signal ra (ST9). The processing of ST7 to ST9 is repeated (ST10: No), until the retracting operation is completed, that is, the required number of the internal command signals ra for achieving the retracting operation is generated.

The command generation unit 15a notifies the status-display output unit 16 of whether or not the retracting operation is completed. When receiving a notification that the retracting operation is not yet completed, the status-display output unit 16 displays, on the status display unit 17, a fact that the retracting operation is in progress, and outputs “the status signal A=the retracting operation in progress” to the controller 3a (ST11). On the other hand, when receiving a notification that the retracting operation is completed, the status-display output unit 16 displays, on the status display unit 17, a fact that the retracting operation is completed, and outputs “the status signal A=completion of the retracting operation” to the controller 3a (ST12).

Next, operations of generating the internal command signal ra will be described with reference to FIGS. 3 and 4. In FIGS. 3 and 4, a horizontal axis represents a time and a vertical axis represents a motor position. Shown in FIG. 3 is an example where a retraction trajectory 21 having the same slope as a motor trajectory 20 prior to occurrence of an abnormality but with an inverse gradient is traced. Shown in FIG. 4 is an example where a retraction trajectory 22 having a smaller slope than that of the motor trajectory 20 prior to occurrence of an abnormality but with an inverse gradient is traced.

In FIG. 3, a value N1, a value N1−1, a value N1−2, and a value N1−3 represented on the motor trajectory 20 at a regular interval T1, respectively indicating the motor positions, correspond to the motor drive information stored in the storage unit 14a at the regular interval. When receiving a notification of occurrence of an abnormality, the command generation unit 15a reads, from the storage unit 14a, the motor drive information N1 as position information Sa1, the motor drive information N1−1 as position information Sa1+1, the motor drive information N1−2 as position information Sa1+2, and the motor drive information N1−3 as position information Sa1+3, respectively. Then, the read position information Sa1, Sa1+1, Sa1+2, and Sa1+3 are interpolated with the same interval T1 as in the case of the motor trajectory 20, and thereby the internal command signal ra for tracing the retraction trajectory 21 having the same slope as the motor trajectory 20 prior to the occurrence of the abnormality but with an inverse gradient is generated.

In FIG. 4, when receiving a notification of occurrence of an abnormality, the command generation unit 15a reads, from the storage unit 14a, the motor drive information N1 as position information Sb1, the motor drive information N1−1 as position information Sb1+1, the motor drive information N1−2 as position information Sb1+2, and the motor drive information N1−3 as position information Sb1+3, respectively. Then, the read position information Sb1, Sb1+1, Sb1+2, and Sb1+3 are interpolated with an interval T2 larger than the interval T1 in the case of the motor trajectory 20, and thereby the internal command signal ra for tracing the retraction trajectory 22 having a smaller slope than that of the motor trajectory 20 prior to the occurrence of the abnormality but with an inverse gradient is generated.

The examples shown in FIGS. 3 and 4 have the following relationship, for example. When an abnormality that disables normal driving of the motor occurs, the motor is so driven as to trace back to the past at the same motor speed as compared with the motor speed prior to the occurrence of the abnormality to move to the position Sa1+3 and then stopped, as shown in FIG. 3. In an operation thereafter, an abnormality that disables normal driving of the motor occurs again. In this case, the retraction process is changed. At this time, as shown in FIG. 4, the motor is so driven as to trace back to the past at a lower speed as compared with the motor speed prior to the occurrence of the abnormality to move to the position Sb1+3 and then stopped.

According to the first embodiment, as described above, the motor drive information is stored in the storage unit at a regular interval, during a period when a normal operation is performed. When an abnormality occurs, the internal command signal with which the motor can be driven is generated from the motor drive information stored in the storage unit. It is therefore possible to achieve a necessary retracting operation without any problem even if the command signal R cannot be obtained from the controller. Moreover, since the retracting operation is performed by the motor control device, the controller needs not to constantly calculate a retraction program and store move amount. It is thus possible to avoid increase in a device size of the controller, which also is advantageous.

### Second Embodiment

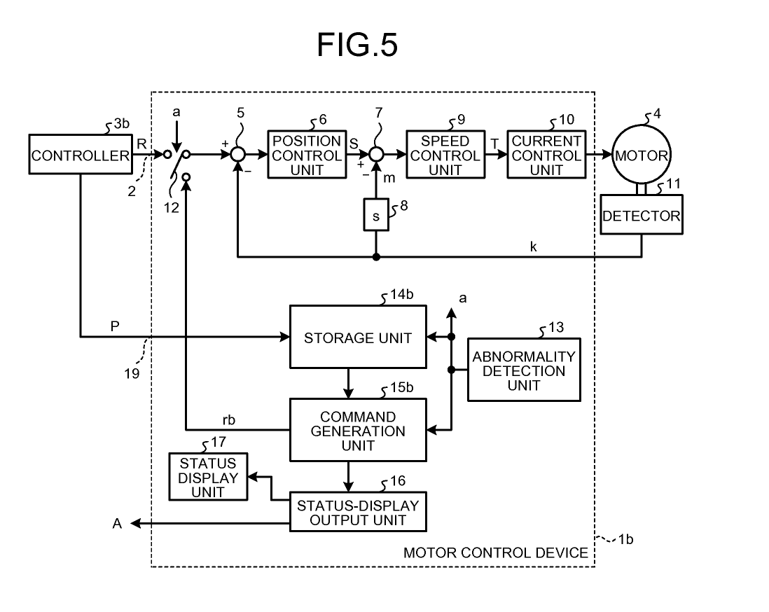

FIG. 5 is a block diagram showing a configuration of a motor control device according to a second embodiment of the present invention. It should be noted in FIG. 5 that the same reference signs are given to the same or equivalent constituent elements as those described in FIG. 1 (the first embodiment). A part related to the second embodiment will be mainly described below.

In FIG. 5, a controller 3b (reference sign is changed) outputs a retraction position P as well as the command signal R. In a case of a motor control device 1b according to the second embodiment, the retraction position P output from the controller 3b instead of the motor drive information in the case of the first embodiment is input through a communication port 19 to and stored in a storage unit 14b whose reference sign is changed from that in the configuration shown in FIG. 1 (the first embodiment).

Furthermore, a command generation unit 15b (reference sign is changed) generates an internal command signal rb based on the retraction position P stored in the storage unit 14b. The internal command signal rb is generated such that the retracting operation is completed within a range of any one of a preset operation time, a preset operation distance, and a remaining amount of electric power. The other configurations are similar to those in FIG. 1.

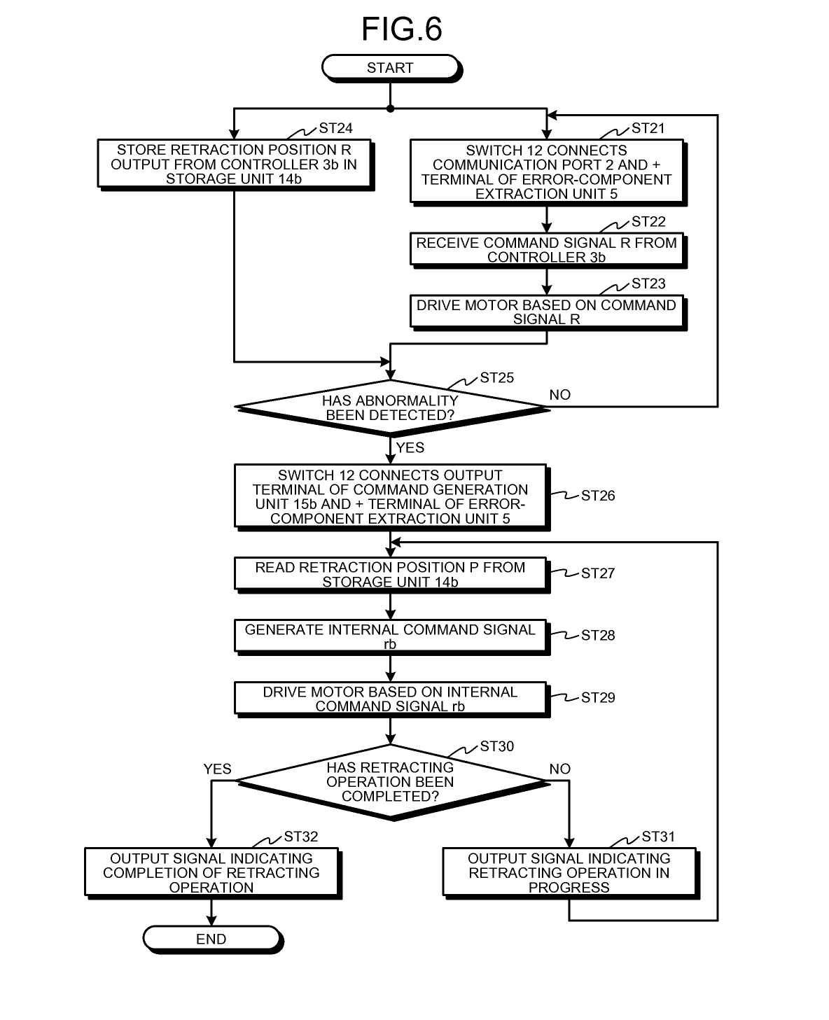

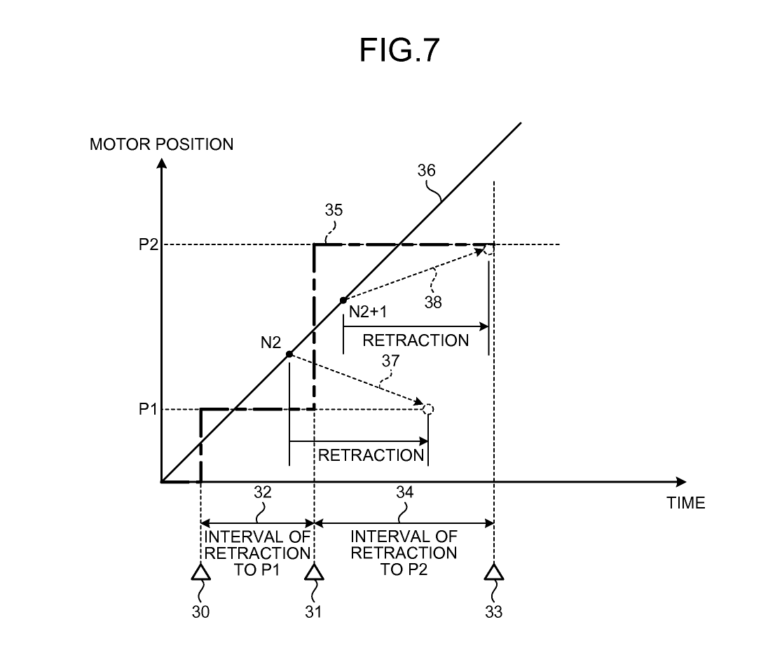

Operations of the part related to the second embodiment will be described below with reference to FIGS. 6 and 7. FIG. 6 is a flowchart for explaining a procedure of the retracting operation performed by the motor control device shown in FIG. 5 when the motor control device detects an abnormality such as an electric power failure that disables normal driving of the motor. FIG. 7 is an explanatory diagram of an operation of generating the internal command signal in the command generation unit shown in FIG. 5.

In FIG. 6, at ST21, the switch 12 connects the communication port 2 and the addition input terminal (+) of the error-component extraction unit 5. As a result, the command signal R input from the controller 3b to the communication port 2 is input to the addition input terminal (+) of the error-component extraction unit 5 (ST22), and motor driving is performed based on the command signal R (ST23). Concurrently, the retraction position P output from the controller 3b is stored in the storage unit 14b (ST24). The processing of ST21 to ST24 is repeated (ST25; No), until the abnormality detection unit 13 detects occurrence of an abnormality. The retraction position P stored in the storage unit 14b is overwritten every time it is changed (ST24).

If the abnormality detection unit 13 detects occurrence of an abnormality (ST25: Yes), the switch 12 switches the command signal to be input to the addition input terminal (+) of the error-component extraction unit 5 from the command signal R output from the controller 3b to the internal command signal rb generated and output by the command generation unit 15b (ST26).

When the abnormality detection unit 13 detects occurrence of the abnormality (ST25: Yes), the command generation unit 15b reads the retraction position P from the storage unit 14b (ST27), and performs interpolation for forming a retraction path whose target position is the retraction position P to generate the internal command signal rb (ST28). As a result, the internal command signal rb is input to the addition input terminal (+) of the error-component extraction unit 5, and thus motor driving is performed based on the internal command signal rb (ST29). The processing of ST27 to ST29 is repeated (ST30: No), until the retracting operation is completed, that is, the internal command signal rb that completes the retracting operation within a range of any one of a preset operation time, a preset operation distance, and a remaining amount of electric power is generated in ST28.

The command generation unit 15b notifies the status-display output unit 16 of whether or not the retracting operation is completed. When receiving a notification that the retracting operation is not yet completed, the status-display output unit 16 displays, on the status display unit 17, a fact that the retracting operation is in progress, and outputs “the status signal A=the retracting operation in progress” to the controller 3b (ST31). On the other hand, when receiving a notification that the retracting operation is completed, the status-display output unit 16 displays, on the status display unit 17, a fact that the retracting operation is completed, and outputs “the status signal A=completion of the retracting operation” to the controller 3b (ST32).

Next, an operation of generating the internal command signal rb will be described with reference to FIG. 7. In FIG. 7, a horizontal axis represents a time and a vertical axis represents a motor position. Two retraction positions P1 and P2 (P1<P2) among a plurality of retraction positions output from the controller 3b are shown on the vertical axis. It should be noted that the retraction position stored in the storage unit 14b is the latest retraction position. The retraction position P1 is output within a period 32 (an interval of retraction to the retraction position P1) from a retraction update point 30 to a retraction update position 31. The retraction position P2 is output within a period 34 (an interval of retraction to the retraction position P2) from the retraction update point 31 to a retraction update position 33. Therefore, a trajectory 35 of the retraction positions output from the controller 3b is changed in a stepwise manner.

A diagonally right-up straight line 36 represents a motor trajectory based on the command signal R output from the controller 3b. A point N2 and a point N2+1 on the motor trajectory 36 respectively indicate timings at which abnormalities that disable the normal driving of the motor occur. The point N2 is located within the period 32, and the point N2+1 is located within the period 34.

When the abnormality occurs at the point N2 located within the period 32, the command generation unit 15b generates the internal command signal rb that is interpolated to cause a retraction path whose target position is the retraction position P1 as indicated by an arrow 37. As a result, the retracting operation whose target position is the retraction position P1 is executed in response to the abnormality occurred at the point N2.

Similarly, when the abnormality occurs at the point N2+1 located within the period 34, the command generation unit 15b generates the internal command signal rb that is interpolated to cause a retraction path whose target position is the retraction position P2 as indicated by an arrow 38. As a result, the retracting operation whose target position is the retraction position P2 is executed in response to the abnormality occurred at the point N2+1.

According to the second embodiment, as described above, it is possible to drive toward an arbitrarily-set retraction position specified by the controller. Therefore, the retraction can be achieved even when a retraction direction is limited due to a condition such as the machining status or machine attitude.

In the second embodiment, a retracting operation by using a single retraction position has been explained; however, a configuration wherein a plurality of retraction positions managed with sequential numbers are used and the retraction operation of the motor is performed to trace their trajectory also is possible in a similar manner.

In the first and second embodiments, a method of performing the retracting operation when the abnormality is detected has been explained. Besides the abnormality, it is also possible to start the retracting operation in response to another signal received from the controller. With this configuration, it is possible to simulate the retracting operation of the motor control device, triggered by the controller.

The invention of the present application is not limited to the above-described embodiments, and when the present invention is carried out, the invention can be variously modified without departing from the scope thereof. In the above embodiments, inventions of various stages are included, and various inventions can be extracted by appropriately combining a plurality of constituent elements disclosed herein. For example, even when some constituent elements are omitted from all the constituent elements described in the embodiments, as far as the problems mentioned in the section of Solution to Problem can be solved and effects mentioned in the section of Advantageous Effects of Invention are obtained, the configuration from which these constituent elements have been omitted can be extracted as an invention. Furthermore, constituent elements common to different embodiments can be appropriately combined.

### INDUSTRIAL APPLICABILITY

As described above, the motor control device according to the present invention is useful as a motor control device that can cause a motor to perform a retracting operation without fail even when a command signal cannot be obtained from a controller in a case where an abnormality occurs. In particular, the motor control device according to the present invention is suitable for a motor control device that drives a motor in an industrial machine apparatus based on a command signal received from a controller.

### REFERENCE SIGNS LIST

1a, 1b motor control device

2, 19 communication port

3a, 3b controller

4 motor

5, 7 error-component extraction unit

6 position control unit

8 differentiating unit

9 speed control unit

10 current control unit

11 detector

12 switch

13 abnormality detection unit

14a, 14b storage unit

15a, 15b command generation unit

16 status-display output unit

17 status display unit

1. A motor control device comprising:
a motor drive unit configured to drive a motor to follow a command signal to be input;
an abnormality detection unit configured to monitor whether or not an abnormality such as an electric power failure that disables normal driving of the motor occurs;
a command switching unit configured to input, when the abnormality detection unit does not detect the abnormality, a first command signal received from a controller as the command signal to the motor drive unit, and to input, when the abnormality detection unit detects the abnormality, a second command signal generated within the motor control device as the command signal to the motor drive unit;
a storage unit configured to sample, when the abnormality detection unit does not detect the abnormality, motor drive information in the motor drive unit at an arbitrarily-set regular interval and stores therein the sampled motor drive information; and
a command generation unit configured to read, when the abnormality detection unit detects the abnormality, a predetermined number of pieces of the motor drive information in order of time from occurrence of the abnormality to past from the storage unit to generate the second command signal that causes a retraction path tracing back a trajectory of the motor from a time of the occurrence of the abnormality.

2. The motor control device according to claim 1,
wherein the motor drive information stored in the storage unit includes any one of or a combination of a command position or a command speed indicated by the first command signal received from the controller and a motor position or a motor speed being a feedback signal to the motor drive unit.

3. A motor control device comprising:
a motor drive unit configured to drive a motor to follow a command signal to be input;
an abnormality detection unit configured to monitor whether or not an abnormality such as an electric power failure that disables normal driving of the motor occurs;
a command switching unit configured to input, when the abnormality detection unit does not detect the abnormality, a first command signal received from a controller as the command signal to the motor drive unit, and to input, when the abnormality detection unit detects the abnormality, a second command signal generated within the motor control device as the command signal to the motor drive unit;
a storage unit configured to store and overwrite, when the abnormality detection unit does not detect the abnormality, an arbitraily-set retraction position that is output from the controller along with the first command signal; and
a command generation unit configured to read, when the abnormality detection unit detects the abnormality, the retraction position from the storage unit to generate the second command signal that causes a retraction path whose target position is the read retraction position.

4. The motor control device according to claim 1,
wherein the command generation unit generates the second command signal such that a retracting operation is completed within a range of any one of a preset retracting operation time, a preset retraction movement distance, and a remaining amount of electric power.

5. The motor control device according to claim 1, further comprising a status-display output unit configured to output a signal indicating an operation status of the motor that is driven in accordance with the second command signal generated by the command generation unit.

6. The motor control device according to claim 3,
wherein the command generation unit generates the second command signal such that a retracting operation is completed within a range of any one of a preset retracting operation time, a preset retraction movement distance, and a remaining amount of electric power.

7. The motor control device according to claim 3, further comprising a status-display output unit configured to output a signal indicating an operation status of the motor that is driven in accordance with the second command signal generated by the command generation unit.
